(19) United States
(12) Patent Application Publication
(10) Pub. No.: US 2016/0214088 A1
(43) Pub. Date: Jul. 28, 2016

(54) EXHAUST GAS PURIFICATION CATALYST AND METHOD FOR PRODUCING IT

(71) Applicants: TOYOTA JIDOSHA KABUSHIKI KAISHA, Toyota-shi (JP); NATIONAL UNIVERSITY CORPORATION NAGOYA UNIVERSITY, Nagoya-shi (JP)

(72) Inventors: Shogo SHIRAKAWA, Gotemba-shi (JP); Hirohito HIRATA, Sunto-gun (JP); Tatsuya MIYAZAKI, Susono-shi (JP); Megumi YANAGIDA, Nagoya-shi (JP); Tsukasa TORIMOTO, Nagoya-shi (JP)

(73) Assignees: TOYOTA JIDOSHA KABUSHIKI KAISHA, Toyota-shi (JP); NATIONAL UNIVERSITY CORPORATION NAGOYA UNIVERSITY, Nagoya-shi (JP)

(21) Appl. No.: 15/007,477

(22) Filed: Jan. 27, 2016

(30) Foreign Application Priority Data
Jan. 27, 2015 (JP) 2015-013738

(51) Int. Cl. B01J 23/652; B01J 37/02; B01J 37/34

(52) U.S. Cl. CPC B01J 23/6527; B01J 37/348; B01J 37/02

(57) ABSTRACT

The present invention relates to an exhaust gas purification catalyst that can homogeneously inhibit growth of a plurality of the fine particles at high temperature, and prevent lowering in catalytic activity, as well as a method for producing it. The exhaust gas purification catalyst of the present invention has fine composite metal particles containing a platinum-group metal and tungsten. Moreover, in the exhaust gas purification catalyst of the present invention, when the fine composite metal particles in the exhaust gas purification catalyst have been analyzed by STEM-EDX, the tungsten content of at least 80% of the fine composite metal particles based on number, is in the range of 10% to 350% of the mean content of tungsten in a plurality of the fine composite metal particles.

### TECHNICAL FIELD

The present invention relates to an exhaust gas purification catalyst and to a method for producing it. More specifically, the present invention relates to an exhaust gas purification catalyst that can homogeneously inhibit growth of a plurality of fine particles at high temperature, and prevent lowering in catalytic activity, as well as a method for producing it.

### BACKGROUND ART

The exhaust gas emitted by the internal combustion engines of automobiles and the like, such as gasoline engines or diesel engines of automobiles, includes harmful components such as carbon monoxide (CO), hydrocarbons (HC) and nitrogen oxides (NOx).

It is common, therefore, for exhaust gas purification apparatuses for decomposition removal of such harmful components to be installed in internal combustion engines, thereby detoxifying most of the harmful components by exhaust gas purification catalysts that are deployed in the exhaust gas purification apparatuses.

In the prior art, such exhaust gas purification catalysts are widely known, for example, catalysts wherein a platinum group element such as platinum (Pt), rhodium (Rh) or palladium (Pd) is supported on a porous oxide support such as alumina (Al₂O₃) or the like.

Also, platinum group elements are generally supported not in the form of bulk but as the form of fine particles on the catalyst. This is in order to increase the catalytic activity, since the area-to-weight ratio increases with smaller fine particle size.

However, the fine particles that are exposed to high-temperature exhaust gas produced from the internal combustion engine undergo sintering, thereby potentially lowering their catalytic activity.

Consequently, in consideration of sintering of the fine particles, conventional exhaust gas purification catalysts have been such that an excess of fine particles which are platinum and the like is supported on the supports.

Also, because of the limited production regions for platinum-group metals, and the fact that those production regions are maldistributed in specific regions such as South Africa and Russia, platinum-group metals have become exceedingly expensive rare metals. Furthermore, the amounts of such platinum elements used have increased in association with tightening exhaust gas regulations for automobiles, and concerns exist in regard to their depletion.

Consequently, research is being conducted on development of technologies for reducing the amounts of platinum-group elements used in catalysts and avoiding lowering in catalytic activity at high temperature.

With the exhaust gas purification catalyst of PTL 1, a support is immersed in a solution containing palladium and tungsten, and then calcined to form a solid solution of the palladium and tungsten.

PTL 2 discloses fabrication method of two-element fine metal particles composed of silver and nickel, by sputtering.

### CITATION LIST

### Patent Literature

[PTL 1] Japanese Unexamined Patent Publication No. 3-56140
[PTL 2] Japanese Unexamined Patent Publication No. 2014-158992

### SUMMARY OF THE PRESENT INVENTION

### Problems to be Solved by the Present Invention

In the exhaust gas purification catalyst of PTL 1, the palladium and tungsten can potentially fail to form a homogeneous solid solution in the support.

Therefore, the subject matter of the present invention provides an exhaust gas purification catalyst that can homogeneously inhibit growth of a plurality of fine particles at high temperature, and prevent lowering in catalytic activity, as well as a method for producing it.

### Means for Solving the Problems

The present inventors have found that the problem can be solved by the following technical means.

(1) An exhaust gas purification catalyst comprising fine composite metal particles containing a platinum-group metal and tungsten, wherein when the fine composite metal particles in the exhaust gas purification catalyst have been analyzed by STEM-EDX, the tungsten content of at least 80% of the fine composite metal particles based on number, is in the range of 10% to 350% of the mean content of tungsten in a plurality of the fine composite metal particles.

(2) An exhaust gas purification catalyst according to (1), further having a powdered support, and the fine composite metal particles being supported on the powdered support.

(3) An exhaust gas purification catalyst according to (2), wherein the powdered support is a powdered support selected from the group consisting of CeO₂—ZrO₂, SiO₂, ZrO₂, CeO₂, Al₂O₃, TiO₂ and combinations thereof.

(4) A method for producing an exhaust gas purification catalyst, comprising sputtering on a target material containing a platinum-group metal and tungsten.

(5) The method according to (4), further comprising dropping a plurality of fine composite metal particles into the ionic liquid by sputtering.

(6) The method according to (4) or (5), further comprising supporting the fine composite metal particles on a powdered support.

(7) The method according to any one of (4) to (6), wherein the target material is a discoid material in which the platinum-group metal and the tungsten are alternately arranged.

(8) The method according to any one of (5) to (7), wherein the ionic liquid is selected from the group consisting of aliphatic ionic liquids, imidazolium-based ionic liquids, pyridinium-based ionic liquids, and combinations thereof.

### EFFECT OF THE INVENTION

According to the present invention it is possible to provide an exhaust gas purification catalyst that can homogeneously inhibit particle growth of a plurality of fine particles at high temperature, and prevent lowering in catalytic activity, as well as a method for producing it.

### BRIEF DESCRIPTION OF THE DRAWINGS

FIG. 1 is a diagram schematically illustrating the method of the present invention in which an exhaust gas purification catalyst is produced.

FIG. 2 is a diagram schematically illustrating a target material containing palladium and tungsten, to be used in an embodiment of the method of the present invention.

FIG. 3(a) shows a TEM image with a transmission electron microscope (TEM), of the Pd-W fine composite metal particles of Example 1, and FIG. 3(b) shows a histogram prepared upon measuring the particle sizes of a plurality of the Pd-W fine composite metal particles in FIG. 3(a).

FIG. 4(a) shows a TEM image with a transmission electron microscope (TEM), of the Pd-W fine composite metal particles of Example 2, and FIG. 4(b) shows a histogram prepared upon measuring the particle sizes of a plurality of the Pd-W fine composite metal particles in FIG. 4(a).

FIG. 5(a) shows a TEM image with a transmission electron microscope (TEM), of the Pd-W fine composite metal particles of Comparative Example 1, and FIG. 5(b) shows a histogram prepared upon measuring the particle sizes of a plurality of the Pd-W fine composite metal particles in FIG. 5(a).

FIG. 6 shows a TEM image of the amorphous W of Comparative Example 2, taken with a transmission electron microscope (TEM).

FIG. 7(a) to (e) are STEM images from STEM-EDX analysis of the catalyst of Example 1 after a heat durability test, and FIG. 7(f) is a graph showing the proportions (atomic percents) of Pd and W in the fine metal particles measured from FIG. 7(a) to (e).

FIG. 8(a) to (d) are STEM images from STEM-EDX analysis of the catalyst of Example 2 after a heat durability test, and FIG. 8(e) is a graph showing the proportions (atomic percents) of Pd and W in the each fine metal particle measured from FIG. 8(a) to (d).

FIGS. 9(a) and (b) are STEM images from STEM-EDX analysis of the catalyst of Comparative Example 5 after a heat durability test, and FIG. 9(c) is a graph showing the proportions (atomic percents) of Pd and W in the each fine metal particle measured from FIGS. 9(a) and (b).

FIG. 10(a) shows an X-ray diffraction pattern for the catalysts of Examples 1 and 2 and Comparative Example 1 after a heat durability test, and FIG. 10(b) is a magnification of region D of FIG. 10(a), showing diffraction on the Pd(111) plane.

FIG. 11 is bar graph showing the relationships between the catalysts of Examples 1 and 2, and Comparative Example 1 and the particle sizes (nm) of the fine metal particles contained in it, respectively, after a heat durability test.

FIGS. 12(a), (b), and (c) are graphs showing the relationship for NO conversion rate (%) with respect to change in temperature (° C.), for the catalysts of Example 1, Example 2, and Comparative Example 1, respectively.

FIG. 13 is bar graph showing the relationships between the catalysts of Examples 1 and 2, and Comparative Example 1 and the NO conversion rate (%) at 600° C., respectively.

### DETAILED DESCRIPTION OF THE PRESENT INVENTION

Embodiments of the present invention will now be explained in detail. The present invention is not limited to the embodiments described below, and various modifications may be implemented within the scope of the gist thereof.

### <<Exhaust Gas Purification Catalyst>>

The exhaust gas purification catalyst of the present invention has fine composite metal particles containing a platinum-group metal and tungsten.

The melting point of the fine composite metal particles can be raised, because each fine composite metal particle contains tungsten in the exhaust gas purification catalyst of the present invention. It is thereby possible to inhibit particle growth of the fine composite metal particles, in particular, particle growth of fine particles of platinum-group metals, at a high temperatures such as temperatures of about 1000° C., and to prevent lowering in catalytic activity and to extend the life of the catalyst.

Furthermore, in the exhaust gas purification catalyst of the present invention, when the fine composite metal particles in the exhaust gas purification catalyst have been analyzed by STEM-EDX, the tungsten content of at least 80% of the fine composite metal particles based on number, is in the range of 10% to 350% of the mean content of tungsten in a plurality of the fine composite metal particles.

The tungsten content of a plurality of the fine composite metal particles in the exhaust gas purification catalyst of the present invention is essentially uniform throughout the entirety, such that particle growth of a plurality of fine particles is homogeneously inhibited even under the high temperature mentioned above, thereby making it possible to minimize the use of precious metals such as platinum.

Consequently, while in the prior art excesses of fine particles of platinum or the like have been used as catalysts in anticipation of the lowered catalytic activity that occurs with particle growth of the fine metal particles, the exhaust gas purification catalyst of the present invention has reduced usage of expensive rare metals, and it is thus possible to obtain a low-cost, high-performance, environmentally friendly exhaust gas purification catalyst.

### <Fine Composite Metal Particles>

The fine composite metal particles contain a platinum-group metal and tungsten.

If the mean content of tungsten in a plurality of the fine composite metal particles is 1 atomic percent or greater and 30 atomic percent or less, then it will be possible to obtain a sufficient effect of inhibiting fine particle growth by tungsten, while also adequately ensuring the number of active sites of the platinum-group metal.

Thus, the mean content of tungsten in a plurality of the fine composite metal particles is preferably greater than 0 atomic percent, 1 atomic percent or greater, 3 atomic percent or greater, 5 atomic percent or greater, 7 atomic percent or greater, 10 atomic percent or greater, 12 atomic percent or greater or 15 atomic percent or greater, and preferably 30 atomic percent or less, 20 atomic percent or less, 17 atomic percent or less, 15 atomic percent or less, 13 atomic percent or less or 10 atomic percent or less.

In addition, the content of tungsten in at least 80%, 85%, 90% or 95% of the fine composite metal particles, based on number, may be in the range of 10% to 350%, 20% to 330%, 30% to 300%, 40% to 280%, 50% to 270% or 60% to 250% of the mean content of tungsten in a plurality of the fine composite metal particles.

Thus, it is possible to obtain an adequate effect of inhibiting particle growth of fine metal particles while exhibiting the exhaust gas purification abilityability of the platinum-group metal, and as a result, an exhaust gas purification catalyst can be obtained that can prevent lowering in catalytic activity.

For the purpose of the present invention, the “content” of tungsten in the each fine composite metal particle can be determined by analyzing the fine composite metal particles using STEM-EDX, as the ratio of the number of tungsten atoms with respect to total number of atoms among the tungsten atoms and platinum-group metal atoms in the each fine composite metal particle. Thus, the “mean content of tungsten”, according to the present invention, can be calculated as the mean value upon determining the “content” of tungsten in each particle.

If the particle size of the fine composite metal particles is too large, the area-to-weight ratio will be lowered to reduce eventually the number of active sites of the platinum-group metal, and thereby the finally obtained exhaust gas purification catalyst may not be able to exhibit sufficient exhaust gas purification abilityability.

If the particle size of the fine composite metal particles is too small, the exhaust gas purification catalyst may undergo inactivation.

Thus, the mean particle size of a plurality of the fine composite metal particles may be greater than 0 nm, or 1 nm or greater, or 2 nm or greater. Also, the mean particle size of a plurality of the fine composite metal particles may be a mean particle size of 100 nm or smaller, 70 nm or smaller, 40 nm or smaller, 10 nm or smaller, 7 nm or smaller, or 5 nm, 4 nm or 3 nm or smaller.

In particular, from the viewpoint of efficiently reducing the exhaust gas, preferably the mean particle size of a plurality of the fine composite metal particles is a mean particle size in the range of 1 nm to 5 nm, more preferably a mean particle size in the range of 1 nm to 4 nm, and yet more preferably a mean particle size in the range of 2 nm to 3 nm.

Also, the particle sizes of at least 80%, 85%, 90% or 95% of the fine composite metal particles, based on number, may be in the range of 30% to 200%, 40% to 190%, 50% to 180%, 60% to 170% or 70% to 160% of the mean particle size of a plurality of the fine composite metal particles.

When the fine composite metal particles having such particle sizes are used as catalyst component, then it is possible for the platinum-group metal and tungsten to reliably coexist on the nanolevel, for particle growth of the platinum-group metal to be inhibited by tungsten, for the life of the catalyst to be extended, and for its catalytic ability to be exhibited.

Unless otherwise specified, the term “particle size”, for the purpose of the present invention, is the circle equivalent diameter (Heywood diameter) of the particle which is measured by using means such as a transmission electron microscope (TEM), and the terms “mean particle size” is the arithmetic mean values of the each “particle size” of 10 or more randomly selected particles.

### <Powdered Support>

According to the method of the present invention, the powdered support supports the fine composite metal particles.

According to the method of the present invention, the powdered support supporting the fine composite metal particles is not particularly limited, and any desired metal oxide may be used that is generally used as a powdered support in the technical field of exhaust gas purification catalysts.

Examples of such powdered supports include ceria-zirconia complex oxide (CeO₂—ZrO₂), silica (SiO₂), zirconia (ZrO₂), ceria (CeO₂), alumina (Al₂O₃), titania (TiO₂), and combinations of these.

The content of fine composite metal particles supported by the powdered support is not particularly limited, and for example, it may generally be a content of 0.01 mass % or greater, 0.05 mass % or greater, 0.10 mass % or greater, 0.50 mass % or greater or 1.00 mass % or greater, and a content of 5 mass % or less, 3 mass % or less or 1 mass % or less, based on the total weight of the fine composite metal particles and the powdered support.

The fine composite metal particles used in the exhaust gas purification catalyst of the present invention can be produced by the method of the present invention described below.

### <<Method for Producing Exhaust Gas Purification Catalyst>>

The method for producing an exhaust gas purification catalyst according to the present invention includes sputtering on a target material containing a platinum-group metal and tungsten.

In general, nanosize fine metal particles have an electron energy structure that differs from bulk due a quantum size effect, and exhibit electrical and optical characteristics that depend on their particle size. Furthermore, nanosize fine metal particles that have a very large area-to-weight ratio are expected to function as highly active catalysts.

As an example of methods for producing such nanosize fine metal particles, “co-impregnation methods” is generally known, and this method is such that fine composite metal particles are supported on a powdered support using a mixed solution containing any of various metal element salts.

In such conventional co-impregnation methods, however, with particular combinations of platinum-group metals and tungsten it has not been possible to form fine composite metal particles in which the metal elements co-exist on the nanolevel.

Although it is not our intention to be limited to any particular theory, it is believed that this is due to the exceedingly high oxidation-reduction potential of tungsten, whereby it is difficult to reduce tungsten in solution to the simple metal.

As an example of methods for producing each fine metal particle containing a plurality of metal elements, a method is known, which includesadding sodium borohydride (NaBH₄) as a reducing agent to a mixed solution which contains a salt of each metal element that is to compose the fine metal particles and contains a protective polymer such as polyvinylpyrrolidone (PVP), and then reducing the metal ions in the solution to simple metals.

However, even when a powerful reducing agent such as sodium borohydride has been used, it is still difficult to reduce the tungsten in the solution to metallic tungsten, and it is believed that ionic tungsten remains in the solution.

Even when it uses other methods, such as coprecipitation method, it is believed that it is difficult to obtain each fine composite metal particle with platinum-group metal and tungsten co-existing on the nanolevel, for the same reason as explained for co-impregnation methods.

In contrast, the fine composite metal particles of the method of the present invention can be produced by employing a “dry method” wherein sputtering is carried out on a target material containing a platinum-group metal and tungsten. Thus, by employing the method of the present invention it is possible to produce each fine composite metal particle containing a platinum-group metal and tungsten, while avoiding the problems arising with the wet method described above.

Optionally, the method of the present invention also further includes dropping the fine composite metal particles into the ionic liquid, following the sputtering mentioned above.

In sputtering, generally, the molecules of electrically charged rare gases and the like are accelerated by voltage application and thereby these molecules are impacted against the target material. On this occasion, the fine metal particles or fine composite metal particles that have been knocked off draw electrical charge from the molecules.

By dropping the electrically charged fine metal particles or fine composite metal particles into the ionic liquid, the ionic molecules adhere onto the fine metal particles or fine composite metal particles. This may appropriately minimize aggregation and particle growth of the fine composite metal particles, as a result, the fine composite metal particles are stabilized.

Consequently, by appropriately selecting the ionic liquid used for the method of the present invention, it is possible to control the mean particle size, etc., of the synthesized fine composite metal particles to within the desired range.

The method of the present invention further includes, optionally, supporting the fine composite metal particles on a powdered support.

This process may be carried out at any desired stage, such as simultaneously with or after sputtering, simultaneously with or after dropping the fine metal particles or fine composite metal particles into the ionic liquid, or simultaneously with or after extracting the fine composite metal particles from the ionic liquid.

When the fine composite metal particles are supported on the powdered support, the large area-to-weight ratio of the powdered support can increase the contact surface between the exhaust gas and the fine composite metal particles. This can allow the exhaust gas purification ability of the exhaust gas purification catalyst to be improved.

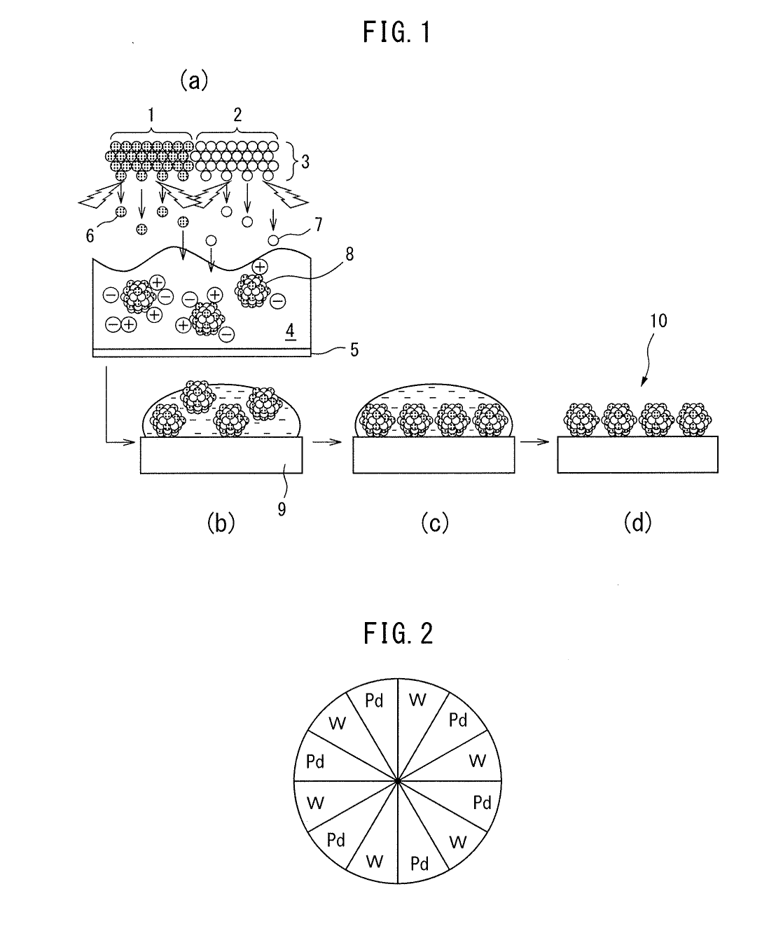

FIG. 1 is a diagram schematically illustrating the method of the present invention in which an exhaust gas purification catalyst is produced. As a detailed explanation of the method of the present invention with reference to FIG. 1, first, for example, a target material 3 containing tungsten 1 and a platinum-group metal 2 are set on a cathode in a sputtering apparatus, and a glass substrate 5 or the like bearing an ionic liquid 4 is arranged on an anode.

Next, the interior of the chamber of the sputtering apparatus is filled with an inert gas such as a rare gas or nitrogen, and especially a reduced pressure atmosphere containing argon (Ar) gas, and a high voltage is applied to the cathode. This generates glow discharge between the cathode and the anode, and Ar ions and the like produced by the glow discharge are impacted against the target material 3. The impact causes the tungsten atoms 6 and the atoms 7 of the platinum-group metal in the target material 3 to fly off, the atoms falling into the ionic liquid 4 as shown in FIG. 1(a), and forming fine composite metal particles 8.

The surfaces of the fine composite metal particles 8 become δ+ charged. Thus, presumably, the ionic liquid 4 that has an ionic property adheres onto the surfaces of the δ+ charged fine composite metal particles 8, whereby the ionic liquid 4 acts as a protective agent with respect to the fine composite metal particles 8, minimizing aggregation and particle growth of the fine composite metal particles 8 and allowing stabilization to be achieved.

Next, the ionic liquid 4 containing the fine composite metal particles 8 is taken out from the sputtering apparatus, and the powdered support 9 is introduced into the ionic liquid 4 (FIG. 1(b)).

The obtained dispersion is then brought to a suitable temperature by heating or the like, to support the fine composite metal particles 8 on the powdered support 9 (FIG. 1(c)).

The powder is separated from the dispersion by filtration, and then if necessary the ionic liquid is thoroughly removed by rinsing or the like, after which the powder is, for example, dried to obtain an exhaust gas purification catalyst 10 having a plurality of the fine composite metal particles 8 supported on the powdered support 9 (FIG. 1(d)).

### <Target Material>

According to the method of the present invention, the target material contains a platinum-group metal and tungsten.

The platinum-group metal is not particularlylimited, but includes platinum (Pt), rhodium (Rh), palladium (Pd), ruthenium (Ru), osmium (Os) and iridium (Ir). Among these, platinum, rhodium, and/or palladium are preferred as exhaust gas purification catalyst metals, with rhodium and palladium being particularly preferred because of their high NOx reduction ability.

As target materials containing platinum-group metals and tungsten there may be used any desired appropriate materials, with no particular limitations, and for example, there may be used a target material having an alternating arrangement of a platinum-group metal and tungsten, a micro-mixed target material obtained by mixing, molding, and sintering a platinum-group metal powder and tungsten powder, or the like.

A target material in which a platinum-group metal and tungsten are alternately arranged may employ a discoid material in which the platinum-group metal and tungsten are alternately arranged. Using such a discoid target material, it is possible to appropriately alter the area and area ratio of the platinum-group metal and tungsten, thereby allowing relatively easy synthesis of fine composite metal particles having the desired compositional ratio of the platinum-group metal and tungsten.

According to one preferred mode of the method of the present invention, the target material used may be, for example, a discoid material in which a palladium plate and a tungsten plate are alternately arranged in a radial manner, as shown in FIG. 2.

However, the ease of fly-off of the metal by sputtering will differ depending on the different metal elements. The compositional ratio may therefore be determined in consideration of the ease of fly-off of the platinum-group metal and tungsten.

Incidentally, the compositional ratio with which the platinum-group metal powder and the tungsten powder are mixed may correlate with the compositional ratio of the platinum-group metal and tungsten in the each fine composite metal particle produced by sputtering. Thus, for example, if the target mean contents for the platinum-group metal and tungsten in the fine composite metal particles are each set as desired being X atomic percent and (100-X) atomic percent (where X is a positive integer), respectively, the compositional ratio of the platinum-group metal and tungsten in the target material is preferably X:(100-X).

### <Sputtering>

According to the method of the present invention, sputtering is carried out on a target material containing a platinum-group metal and tungsten, in order to produce each fine composite metal particle containing the platinum-group metal and tungsten.

Such sputtering may be carried out under any desired appropriate conditions including, for example, the gas component, gas pressure and sputtering current, voltage, time and number of times.

The gas component to be used for the sputtering may be an inert gas, such as helium (He), neon (Ne), argon (Ar), krypton (Kr), xenon (Xe) or nitrogen (N₂). Among those, Ar and N₂ are preferred from the viewpoint of ease of handling.

The gas pressure used for the sputtering may be optionally selected so long as it is a gas pressure that allows plasma to be produced, but it is generally preferred to be no greater than 20 Pa.

The current and voltage used for the sputtering may be appropriately set according to the composition of the target material, the sputtering apparatus, etc.

The sputtering time may be set as appropriate in consideration of the desired accumulation amount of the fine composite metal particles and other parameters, and is not particularly limited, but for example, it may be appropriately set within a range of several tens of minutes to several hours or to several tens of hours.

The sputtering number of times may be divided into several times over several hours, in order to prevent the temperature of the fine composite metal particles that are produced from the target material from increasing to the high temperature resulting in sintering and the like when, for example, sputtering is conducted for a long period of time. Sintering refers to the phenomenon of particle growth of fine metal particles at a temperature of below their melting point.

### <Ionic Liquid>

According to the method of the present invention, the fine composite metal particles are dropped into the ionic liquid by sputtering.

An ionic liquid has advantageous properties such as stability at high temperature, liquid temperature over a wide range, approximately zero vapor pressure, viscosity, and high oxidation/reduction resistance while maintaining ionic properties, and it can exist stably as a liquid without vaporizing even under sputtering conditions, such as the vacuum or reduced pressure conditions, of the method of the present invention.

In addition, even when exposed to high temperatures during sputtering, the ionic liquid can exist stably without decomposing, due to its high-temperature stability.

Furthermore, the ionic liquid may be hydrophilic or hydrophobic, and its type is not particularly limited, but it may be an aliphatic-based ionic liquid, imidazolium-based ionic liquid, pyridinium-based ionic liquid, or a combination thereof, for example.

### (Other)

As regards the aforementioned constituent elements and other constituent elements, it may refer to the description above for the exhaust gas purification catalyst, and to the description in PTL 2.

The present invention will now be explained in further detail with reference to examples, with the understanding that the scope of the present invention is naturally not limited to the examples or their descriptions.

### EXAMPLES

### Example 1

### (Production of Pd-W Fine Composite Metal Particles by Sputtering)

### <Preparation of Ionic Liquid>

BMI-PF6 was taken in an amount of 2.4 cm³ for the ionic liquid and dried under reduced pressure at 105° C. for 1 hour while heating, to prepare an ionic liquid. BMI-PF6 can be represented by the following structural formula.

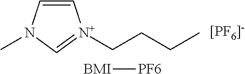

### <Production of Catalyst>

Refering to FIG. 2, a discoid alternately-arranged target comprising a tungsten (W) plate and a palladium (Pd) plate as the platinum-group metal, alternately arranged in a radial manner (the W plate being attached to the Pd plate with carbon tape, with an area ratio of Pd:W=58:42) was set in a sputtering apparatus (SC-701HMCII4 by Sanyu Electron).

Next, the chamber interior of the sputtering apparatus was exchanged twice with Ar gas, and pre-sputtering was carried out for 30 minutes under conditions with a pressure of 3.0 Pa and a sputtering current of 20 mA, to produce a condition allowing stable sputtering.

The BMI-PF6 was then spread evenly over a petri dish (diameter: 70 mm) and placed in the sputtering apparatus, and then dried under reduced pressure for 30 minutes.

Next, sputtering was conducted for 300 minutes with a pressure of 3.0 Pa, a sputtering current of 20 mA, and a distance of 6.7 cm between the target material and the BMI-PF6.

The ionic liquid in the dish was then recovered to obtain a dispersion containing Pd-W fine composite metal particles. As a result of fluorescent X-ray analysis, the concentrations of Pd and W in the dispersion were 100.5 mM Pd and 9.6 mM W. Based on the analysis results, the mean contents of Pd and W in the Pd-W fine composite metal particles were calculated to be 91.3 atomic percent and 8.7 atomic percent, respectively.

### <Catalyst Supporting Process>

Next, 3.3 g of a ceria-zirconia complex oxide (CeO₂—ZrO₂: product of Rhodia) as a powdered support was dispersed in 4 mL of acetonitrile to prepare a solution. The solution was mixed in a 50 mL flask with 3 mL of a dispersion containing the Pd-W fine composite metal particles, to prepare a mixed dispersion.

The mixed dispersion was then heated and stirred at 150° C. for 30 minutes under a nitrogen stream. After cooling the obtained dispersion, the powder was separated from the dispersion by filtration and rinsed 3 times with acetonitrile to thoroughly remove the BMI-PF6.

Next, the obtained powder was dried in air at 110° C. for 5 hours to obtain an exhaust gas purification catalyst. Based on the total mass of the Pd-W fine composite metal particles and ceria-zirconia complex oxide, the Pd content was 1.00 mass % and the W content was 0.17 mass %.

### Example 2

### (Production of Pd-W Fine Composite Metal Particles by Sputtering)

An ionic liquid was prepared, a catalyst was produced and catalyst supporting processes were carried out, in the same manner as Example 1 other than the alternately arranged target used had an area ratio of Pd:W=42:58.

As a result of fluorescent X-ray analysis conducted during production of the catalyst, the Pd and W concentrations in the dispersion were 74.1 mM Pd and 18.0 mM W. Based on the analysis results, the mean contents of Pd and W in the Pd-W fine composite metal particles were calculated to be 80.5 atomic percent and 19.5 atomic percent, respectively.

Also, in the catalyst supporting process, based on the total mass of the Pd-W fine composite metal particles and ceria-zirconia complex oxide, the Pd content was 0.99 mass % and the W content was 0.43 mass %.

### Comparative Example 1

### (Production of Pd Fine Metal Particles by Sputtering)

### <Preparation of Ionic Liquid>

An ionic liquid was prepared in the same manner as Example 1, other than the temperature at which the ionic liquid was dried under reduced pressure was 120° C.

### <Production of Catalyst>

A discoid Pd target was set inside a sputtering apparatus (same as above).

The BMI-PF6 was then spread evenly over a petri dish (diameter: 70 mm) and placed in the sputtering apparatus, and then dried under reduced pressure for 30 minutes.

Next, sputtering was conducted for 120 minutes with a pressure of 3.0 Pa, a sputtering current of 20 mA, and a distance of 6.7 cm between the target material and the BMI-PF6 ionic liquid.

The ionic liquid in the dish was then recovered to obtain a dispersion containing fine metal particles. As a result of fluorescent X-ray analysis, the concentration of Pd in the dispersion was 113.7 mM.

### <Catalyst Supporting Process>

A fine metal particle supporting process was carried out in the same manner as Example 1. Based on the total mass of the Pd fine metal particles and ceria-zirconia complex oxide, the Pd content was 1.01 mass %.

### Comparative Example 2

### (Production of W Fine Metal Particles by Sputtering)

An ionic liquid was prepared in the same manner as Comparative Example 1, other than for production of the catalyst, the Pd target was changed to a discoid W target, and the procedure of sputtering for 150 minutes and for 300 minutes was repeated 3 times.

A catalyst was produced in the same manner as Comparative Example 1. As a result of fluorescent X-ray analysis carried out during production of the catalyst, the concentration of W in the dispersion was 75.6 mM.

The catalyst was supported in the same manner as Comparative Example 1. Based on the total mass of the W and ceria-zirconia complex oxide, the W content was 1.72 mass %.

### Comparative Example 3

### (Synthesis of Pd Catalyst by Impregnation)

After mixing 50 mL of distilled water and 0.6 g of palladium nitrate in a 300 mL beaker, they were stirred at room temperature to completely dissolve the palladium nitrate. Next, the solution was mixed with 30 g of a ceria-zirconia complex oxide, and the mixture was heated, thereby vaporizing the solvent.

Also, after drying the mixture at 120° C. for 1 hour, it was pulverized with a mortar and calcined at 500° C. for 2 hours to obtain a Pd catalyst. Based on the total mass of the Pd catalyst, the Pd content was 1.02 mass %.

### Comparative Example 4

### (Synthesis of W Catalyst by Impregnation)

After mixing 50 mL of distilled water and 1.0 g of tungsten hexachloride (WCl₆) in a 300 mL beaker, they were stirred at room temperature to completely dissolve the tungsten hexachloride. Next, the solution was mixed with 26 g of a ceria-zirconia complex oxide, and the mixture was heated, thereby vaporizing the solvent.

Also, after drying the mixture at 120° C. for 1 hour, it was pulverized with a mortar and calcined at 500° C. for 2 hours to obtain a W catalyst. Based on the total mass of the W catalyst, the W content was 1.75 mass %.

### Comparative Example 5

### (Synthesis of Mixed Catalyst Comprising Pd Catalyst and W Catalyst, by Impregnation)

A Pd catalyst was synthesized in the same manner as Comparative Example 3, other than palladium nitrate was used at 0.27 g. Also, a W catalyst was synthesized in the same manner as Comparative Example 4, other than tungsten hexachloride was used at 0.11 g.

The Pd catalyst and W catalyst were mixed and pulverized with a mortar to obtain a mixed catalyst. Based on the total mass of the mixed catalyst, the Pd content was 0.98 mass % and the W content was 0.41 mass %.

### Comparative Example 6

### (Synthesis of Pd-W Catalyst by Reduction Process Using Protective Polymer and Reducing Agent)

A Pd-W catalyst was synthesized using poly-n-vinylpyrrolidone (PVP) as the protective polymer, sodium borohydride as reducing agents, palladium nitrate, tungsten hexachloride and ceria-zirconia complex oxide. Based on the total mass of the Pd-W catalyst, the Pd content was 0.92 mass % and the W content was 0.02 mass %.

The compositions of the catalysts of Examples 1 and 2 and Comparative Examples 1 to 6 are shown in Table 1 below. The catalyst contents (%) were analyzed by ICP-MS (inductively coupled plasma-mass spectrometry).

### <TEM Analysis>

The catalysts of Examples 1 and 2 and Comparative Examples 1 and 2 were analyzed using a transmission electron microscope (TEM) (H-7650 by Hitachi, Ltd.). The samples analyzed were solutions containing the different fine particles of the examples before being supported on the powdered support.

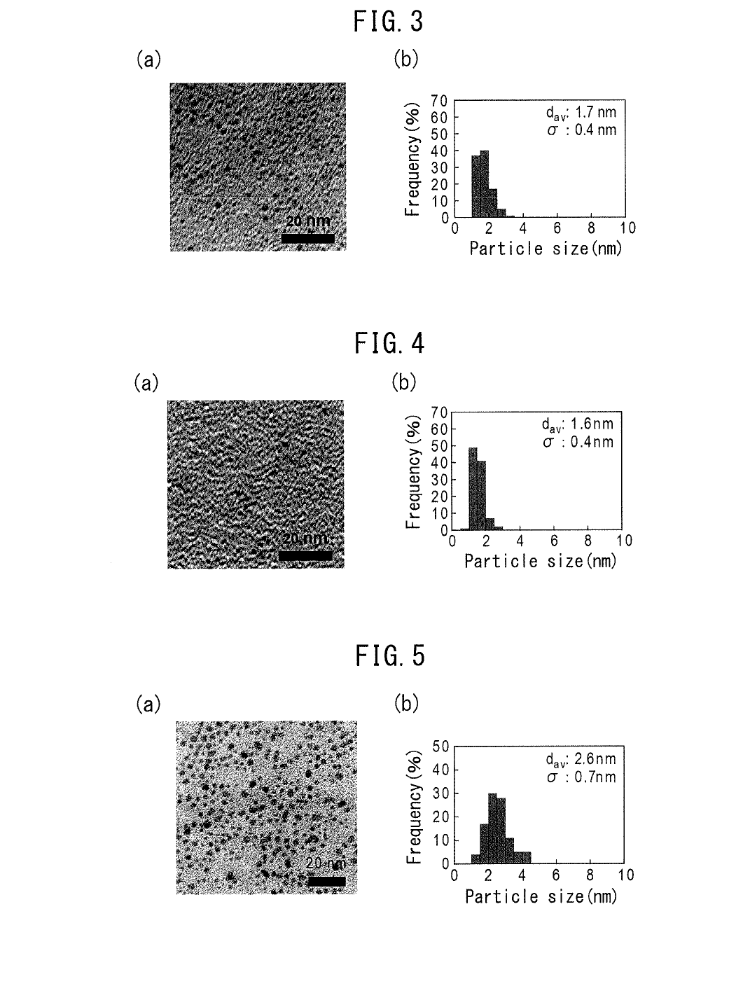

TEM images and/or histograms of the catalysts of Examples 1 and 2 and Comparative Examples 1 and 2 are shown in FIGS. 3 to 6, and the mean particle sizes (dav (nm)) and standard deviations (σ (nm)) of the fine particles measured from the TEM images of the catalysts of Examples 1 and 2 and Comparative Example 1 are shown in Table 1.

TABLE 1
Catalyst compositions

| | | Fine metal particles | | | | | | | |
|---|---|---|---|---|---|---|---|---|---|
| | | | | Mean | | | | | |
| | | | Pd and | particle | | | | Content | |
| | Production | | W mean | size | SD | Ionic | | (mass %) | |
| | method | Component (form) | contents (at %) | (dₐᵥ (nm)) | (δ (nm)) | liquid | Support | Pd | W |
| Example 1 | Sputtering | Pd and W | 91.3 and 8.7 | 1.7 | 0.4 | BMI-PF6 | Ceria-zirconia | 1.00 | 0.17 |
| | | (composite fine particles) | | | | | complex oxide | | |
| Example 2 | Sputtering | Pd and W | 80.5 and 19.5 | 1.6 | 0.4 | BMI-PF6 | Ceria-zirconia | 0.99 | 0.43 |
| | | (composite fine particles) | | | | | complex oxide | | |
| Comparative | Sputtering | Pd (fine particles) | 100 (Pd alone) | 2.6 | 0.7 | BMI-PF6 | Ceria-zirconia | 1.01 | — |
| Example 1 | | | | | | | complex oxide | | |
| Comparative | Sputtering | W (amorphous) | — | — | — | BMI-PF6 | Ceria-zirconia | — | 1.72 |
| Example 2 | | | | | | | complex oxide | | |
| Comparative | Impregnation | Pd (fine particles) | 100 (Pd alone) | — | — | — | Ceria-zirconia | 1.02 | — |
| Example 3 | | | | | | | complex oxide | | |
| Comparative | Impregnation | W (amorphous) | — | — | — | — | Ceria-zirconia | — | 1.75 |
| Example 4 | | | | | | | complex oxide | | |
| Comparative | Impregnation | Pd (fine particles) and | — | — | — | — | Ceria-zirconia | 0.98 | 0.41 |
| Example 5 | | W (amorphous) | | | | | complex oxide | | |
| Comparative | Reduction | Pd (fine particles) and | — | — | — | — | Ceria-zirconia | 0.92 | 0.02 |
| Example 6 | | W (amorphous) | | | | | complex oxide | | |

Specifically, based on the TEM image in FIG. 3(a) and the histogram in FIG. 3(b) for Example 1, it is seen that the particle sizes of the fine composite metal particles are within a range of about 1.0 nm to 3.5 nm, and the particle sizes are in a range of about 60% to 200% of the mean particle size of 1.7 nm.

Also, based on the TEM image in FIG. 4(a) and the histogram in FIG. 4(b) for Example 2, it is seen that the particle sizes of the fine composite metal particles are within a range of about 0.5 nm to 3.0 nm, and the particle sizes are in a range of about 30% to 190% of the mean particle size of 1.6 nm.

Thus, based on FIG. 3 and FIG. 4, it is understood that the fine composite metal particles of Examples 1 and 2 are formed of extremely fine primary particles having mean particle sizes of about 2 nm or smaller, and that the fine composite metal particles exist in a dispersed state.

Based on the TEM image in FIG. 5(a) and the histogram in FIG. 5(b) for Comparative Example 1, it is seen that the particle sizes of the Pd fine metal particles are in the range of about 1.0 nm to 4.3 nm. It is further seen that the fine metal particles exist in a dispersed state.

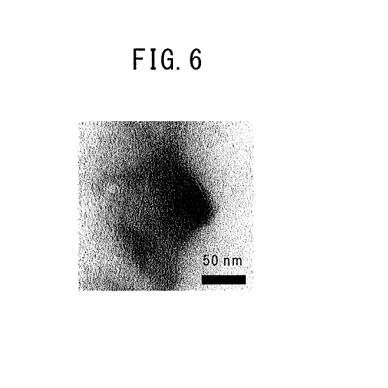

In the TEM image of FIG. 6 for Comparative Example 2, the particles were not observable. It is believed that the tungsten existed as oxides such as WOx, and that the oxides were not crystalline particles but rather in amorphous form.

### <<Evaluation>>

The catalysts of Examples 1 and 2 and Comparative Examples 1 to 6 were evaluated for particle growth-inhibiting effect and exhaust gas purification ability.

### <Evaluation of Particle Growth-Inhibiting Effect>

The evaluation of the particle growth-inhibiting effect was conducted by subjecting the catalyst to a heat durability test, and then analyzing the catalyst fine metal particles with an energy dispersive X-ray analyzer-equipped scanning transmission electron microscope (STEM-EDX) (HD2700 by Hitachi, Ltd.) and an X-ray diffraction (XRD) device (RINT2000 by Rigaku Corp.).

### (Heat Durability Test)

The catalysts of Examples 1 and 2 and Comparative Examples 1 to 6 were calcined at 500° C. for 2 hours, and then 4 g of the catalyst of each example was taken and used as a sample. The heat durability test process was as follows, in (1) to (5).

(1) The sample was placed in a N₂ atmosphere with a gas flow rate of 10 L/min, and was heated from ordinary temperature to 1050° C.;

(2) Upon reaching the target temperature, the atmosphere was changed to a gaseous mixture R, and the sample was exposed to the gaseous mixture R at a flow rate of 10 L/min for a period of 2 minutes;

(3) Next, the atmosphere was changed to a gaseous mixture L, and the sample was exposed to the gaseous mixture L at a flow rate of 10 L/min for a period of 2 minutes;

(4) Processes (2) and (3) were then alternately repeated, so that processes (2) and (3) were carried out for a total number of 150 times. That is, processes (2) and (3) were conducted for a total time of 300 minutes. The procedure was ended with process (2);

(5) The sample was then cooled from 1050° C. to ordinary temperature.

The components forming the gaseous mixture R (rich) were CO: 1%, H₂O: 3% and N₂: balance, while the components forming the gaseous mixture L (lean) were O₂: 5%, H₂O: 3% and N₂: balance.

### (STEM-EDX Analysis)

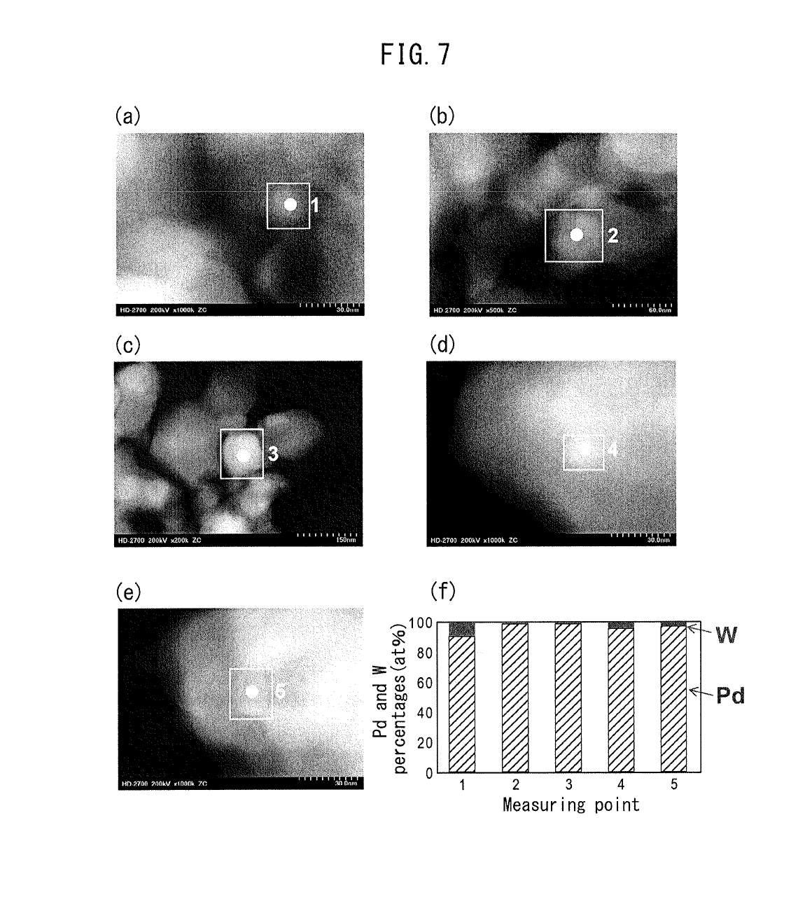

Following the heat durability test, the sample was taken out and subjected to STEM-EDX analysis for the catalysts of Examples 1 and 2 and Comparative Example 5. The results are shown in FIGS. 7 to 9. In the STEM-EDX analysis, single-particle analysis was employed, and extraction of each of the fine particles to be measured was performed by randomly extracting fine particles from the sample.

Based on FIGS. 7(a) to (e) it is seen that the fine particles exist in a dispersed state. In addition, from FIG. 7(f) it is seen that the fine particle at each measurement point in FIGS. 7(a) to (e) contains palladium and tungsten, the tungsten content being about from 2 atomic percent to 10 atomic percent.

Thus, since the mean content (atomic percent) of tungsten (W) in Example 1 in Table 1 is 8.7 atomic percent, and the fine particles at measurement points 1 to 5 contain tungsten at about 2 atomic percent to 10 atomic percent, it is concluded that the tungsten contents of 100% of the fine metal particles, based on number, are in the range of about 20% to 120% of the tungsten mean contents.

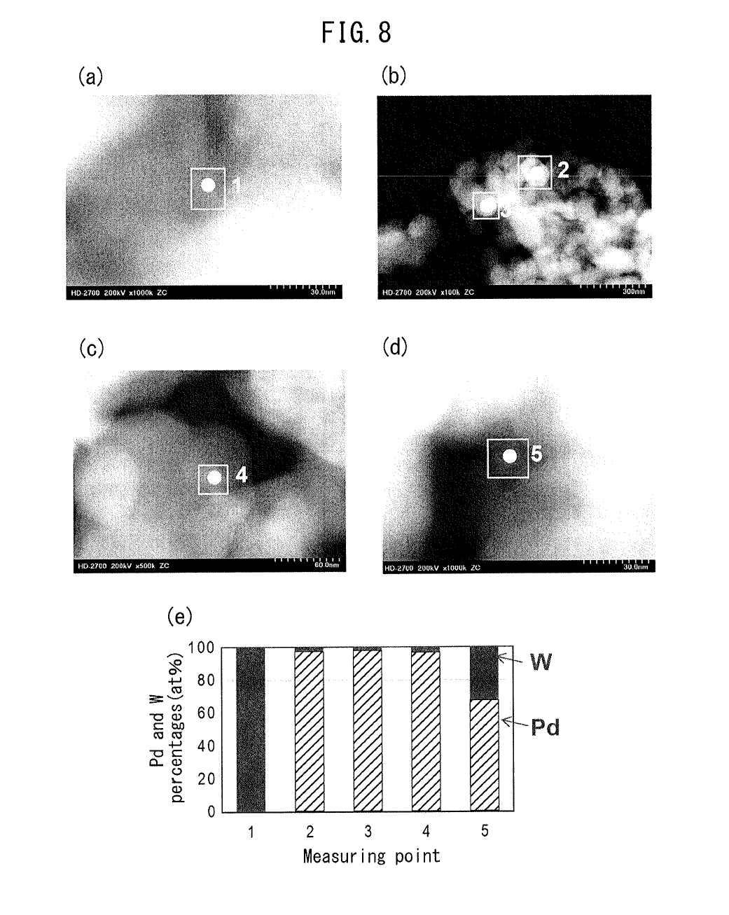

Based on FIGS. 8(a) to (d) it is seen that the fine particles exist in a dispersed state. In addition, from FIG. 8(e) it is seen that the fine particle at each measurement point in FIGS. 8(b) to (d), excluding FIG. 8(a), contains palladium and tungsten, the tungsten content being about from 2 atomic percent to 68 atomic percent.

Thus, since the mean content (atomic percent) of tungsten in Example 2 in Table 1 is 19.5 atomic percent, and the fine particles at measurement points 2 to 5 contain tungsten in the range of about 2 atomic percent to 68 atomic percent, it is concluded that the tungsten contents of at least 80% of the fine metal particles, based on number, are in the range of 10% to 350% of the tungsten mean contents.

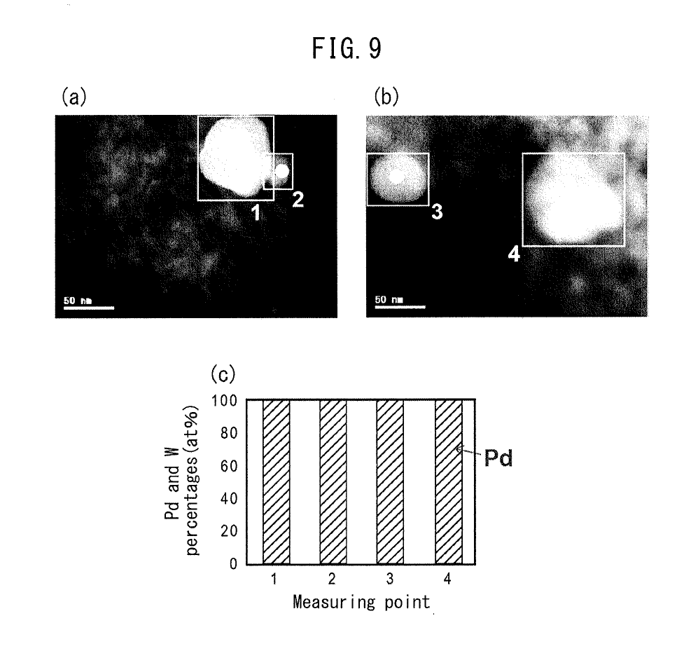

Based on FIG. 9(a) and (b) it is seen that they exist as fine particles and in amorphous form. Also, from FIG. 9(c) it is seen that the fine particle at each measurement point in FIG. 9(a) to (b) contains palladium alone. Also, based on the aforementioned ICP-MS analysis and Table 1, it is seen that in the catalyst of Comparative Example 5, the palladium and tungsten were present at 0.98 mass % and 0.41 mass %, respectively, based on the total mass of the fine metal particles and the support.

Thus, it is seen that while palladium and tungsten were present in the catalyst of Comparative Example 5, the fine particles existed as fine particles composed mainly of Pd, while the tungsten was present not as fine particles but in amorphous form, and virtually no fine particles composed of palladium and tungsten were present.

This is believed to be because the exceedingly high oxidation-reduction potential of tungsten makes it difficult to reduce tungsten in the solution to the simple metal, and therefore with respect to the catalyst of Comparative Example 5 produced by impregnation, it was not possible to produce fine particles composed of palladium and tungsten.

### (XRD Analysis)

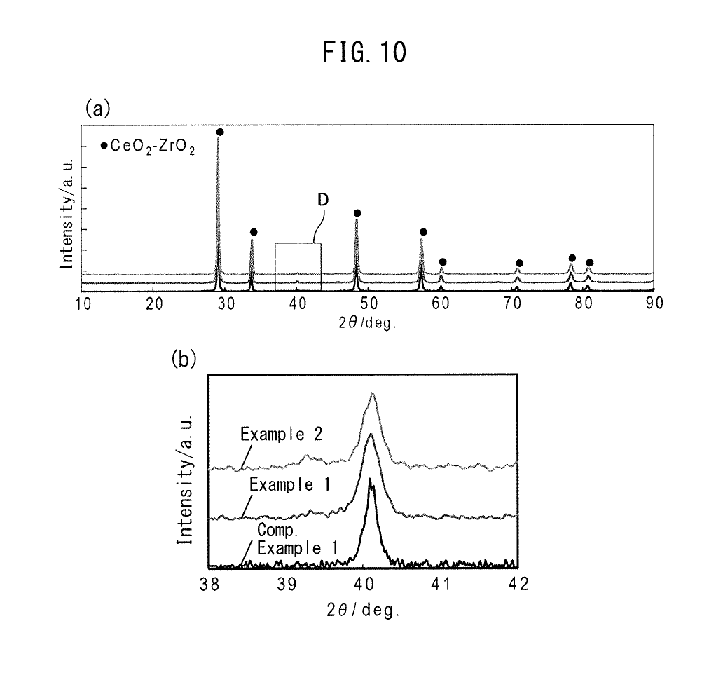

Following the heat durability test, XRD analysis was carried out on the catalysts of Examples 1 and 2 and Comparative Examples 1 to 6. The results are shown in Table 2, and the particular results for Examples 1 and 2 and Comparative Example 1 are shown in FIG. 10.

The measuring conditions for XRD analysis were as follows:

The measuring mode was FT (Fixed Time) mode; the X-ray source was CuKα (1.542 angstrom); the process width was 0.02 deg; the counter time was 0.5 sec; the divergence slit (DS) was ⅔ deg; the scattering slit (SS) was ⅔ deg; the receiving slit (RS) was 0.5 mm; the tube voltage was 50 kV; and the tube current was 300 mA.

Also, based on the results of XRD analysis of the catalyst of each example, the particle size (nm) of the fine metal particles after the heat durability test was determined, using the Scherrer formula. The Scherrer formula may be represented as the following formula (I):

$$\begin{matrix}[ Mathematical Formula 1 ] & \\ τ = \frac{K λ}{βcosθ} & ( I )\end{matrix}$$

[In the formula,

Shape factor: K

X-ray wavelength: λ

Total half-width of peak: β

Bragg angle: θ

Particle size of fine metal particles: τ]

TABLE 2
Particle sizes of fine metal particles following heat durability test

| | | | Particle size |
|---|---|---|---|
| | | | (nm) |
| | | Pd and | following |
| | | W mean | heat durability |
| | Component (form) | contents (at %) | test |
| Example 1 | Pd and W | 91.3 and 8.7 | 30.4 |
| | (composite fine particles) | | |
| Example 2 | Pd and W | 80.5 and 19.5 | 28.1 |
| | (composite fine particles) | | |
| Comparative | Pd (fine particles) | 100 (Pd alone) | 44.5 |
| Example 1 | | | |
| Comparative | W (amorphous) | — | — |
| Example 2 | | | |
| Comparative | Pd (fine particles) | 100 (Pd alone) | 50.1 |
| Example 3 | | | |
| Comparative | W (amorphous) | — | — |
| Example 4 | | | |
| Comparative | Pd (fine particles) and | — | 49.1 |
| Example 5 | W (amorphous) | | |
| Comparative | Pd (fine particles) and | — | — |
| Example 6 | W (amorphous) | | |

FIG. 10(a) shows an X-ray diffraction pattern for the catalysts of Examples 1 and 2 and Comparative Example 1, and FIG. 10(b) is a magnification of region D of FIG. 10(a), showing diffraction on the Pd(111) plane. The peaks indicated by dark circles in FIG. 10(a) represent CeO₂—ZrO₂ as the support.

From FIG. 10(b) it is seen that the fine metal particles of Examples 1 and 2 and Comparative Example 1 contain respectively Pd, and the Bragg angle and total half-width peak for palladium can be read. The Bragg angle is the angle that satisfies the Bragg conditions.

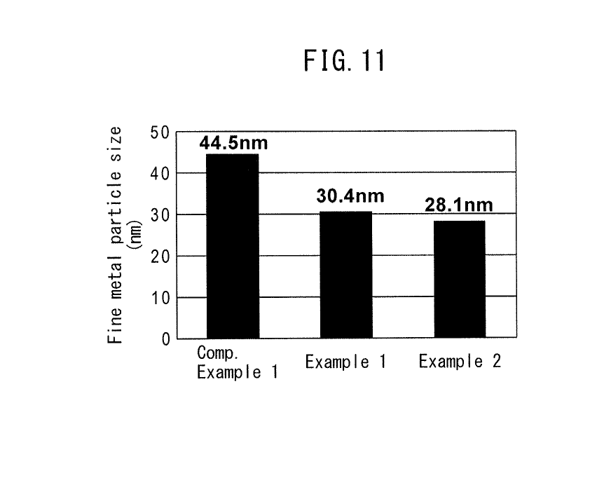

Using the Bragg angle, etc., the particle sizes of the fine metal particles of Examples 1 and 2 and Comparative Example 1 were determined from the Scherrer formula shown above. The results are shown in FIG. 11.

FIG. 11 is bar graph showing the relationships between the catalysts of Examples 1 and 2 and Comparative Example 1 and the particle sizes (nm) of the fine metal particles. From FIG. 11 it is seen that the particle size of the fine metal particles of Comparative Example 1 that were composed of palladium alone was 44.5 nm, whereas the particle sizes of the fine composite metal particles of Examples 1 and 2 that were composed of palladium and tungsten were 30.4 nm and 28.1 nm, respectively.

Consequently, since the particle sizes of the fine composite metal particles of Examples 1 and 2 that were composed of palladium and tungsten were smaller than the particle size of the fine metal particles of Comparative Example 1 that were composed of palladium alone, following the heat durability test, it is seen that particle growth of fine particles was inhibited by the presence of tungsten in the fine composite metal particles composed of palladium and tungsten.

### <Evaluation of Exhaust Gas Purification Ability>

Evaluation of the exhaust gas purification ability was conducted by using an FT-IR analyzer to measure the amount of NOx purified by the catalysts of Examples 1 and 2 and Comparative Examples 1 to 6 when each catalyst was exposed to a test gas as exhaust gas.

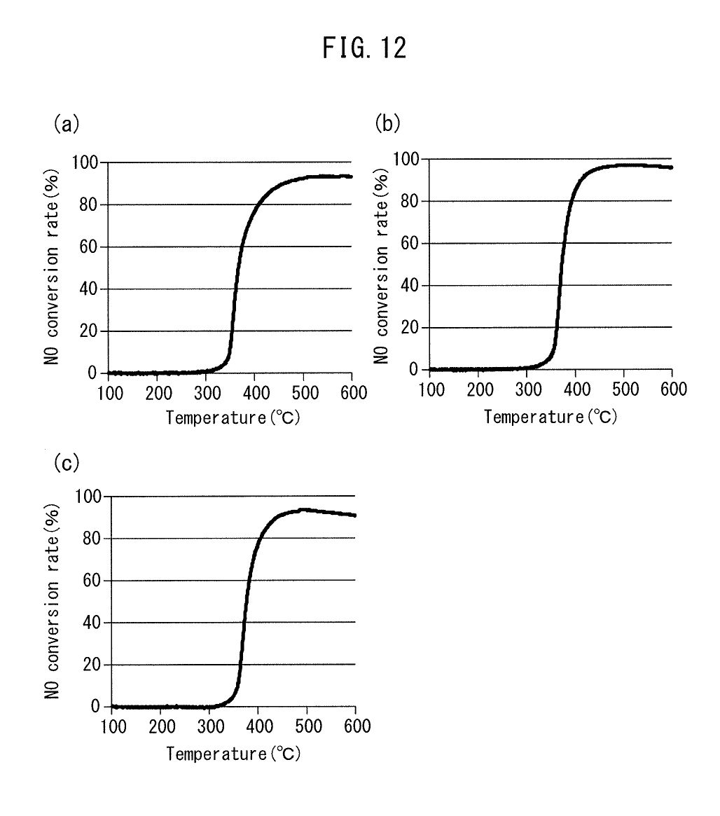

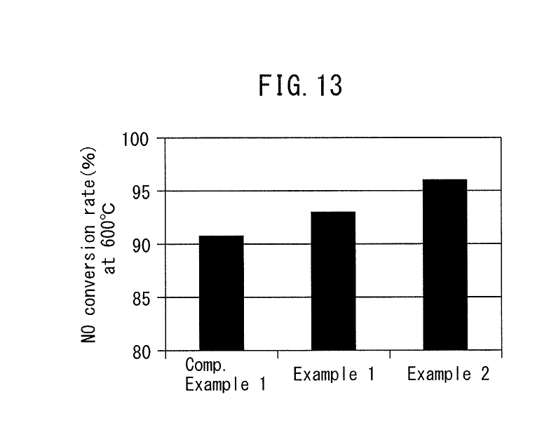

Specifically, 0.3 g of catalyst was taken and set in a flow reactor, and the catalyst was exposed to the test gas at a flow rate of 1 (L/min). During this time, the temperature of the catalyst was increased from 100° C. to 600° C. at a temperature-elevating rate of 20 (° C./min), while recording the NO conversion rate (%) with respect to the catalyst temperature (° C.). The results are shown in FIG. 12 and FIG. 13.

The components forming the test gas were CO: 0.65 vol %, CO₂: 10.00 vol %, C₃H₆: 3000 ppmC (1000 ppm), NO: 1500 ppm, 0₂: 0.70 vol %, H₂O: 3.00 vol % and N₂: balance.

Based on FIG. 12(a) to (c) it is seen that in a temperature range of 100° C. to 400° C., the NO conversion rates (%) of the catalysts of Examples 1 and 2 and Comparative Example 1 were substantially the same, but in a temperature range of 400° C. to 600° C., the NO conversion rates (%) of the catalysts of Examples 1 and 2 increased while the NO conversion rate (%) of the catalyst of Comparative Example 1 decreased.

Furthermore, based on the particle sizes (nm) after the heat durability test, shown in Table 2, the particle sizes of the fine metal particles of Examples 1 and 2 are seen to be smaller than the particle size of the fine metal particles of Comparative Example 1.

This suggests that in a temperature range of 400° C. to 600° C., the fine metal particles of the catalysts of Examples 1 and 2 experienced substantially no particle growth compared to Comparative Example 1, and therefore the decrease in number of active sites of NOx occurring with decreasing area-to-weight ratio of the fine particles was either minimal or virtually absent, and lowering in catalytic activity was prevented.

Consequently, the increase in NO conversion rates (%) of the catalysts of Examples 1 and 2 is presumably due to the fact that lowering in catalytic activity was prevented, and that the NOx purification ability increased kinetically with increased temperature.

On the other hand, presumably since the fine metal particles of the catalyst of Comparative Example 1 underwent particle growth in a temperature range of 400° C. to 600° C., the number of NOx active sites were fewer and the catalytic activity was lowered.

Consequently, it is believed that the decrease in NO conversion rate (%) of the catalyst of Comparative Example 1 is due to the lowering in catalytic activity by particle growth, and that the amount of lowering in catalytic activity could not be compensated for even by the kinetic increase in NOx purification ability associated with increased temperature.

Furthermore, from FIG. 13 it is seen that the NO conversion rate (%) at 600° C. is higher with the catalysts of Examples 1 and 2 than with the catalyst of Comparative Example 1. This is interpreted as indicating that not only did the NOx purification ability of the catalysts of Examples 1 and 2 increase in a temperature range of 400° C. to 600° C., but the catalysts of Examples 1 and 2 also exhibited higher NOx purification ability than the catalyst of Comparative Example 1 at a high temperature of 600° C.

Preferred embodiments of the present invention were described in detail above, but it will be appreciated by a person skilled in the art that the configurations and types of exhaust gas purification catalyst, powdered support, ionic liquid, production apparatus and measuring apparatus used for the present invention may be modified, so long as they remain within the scope of the claims of the present invention.

### Explanation of Symbols

1 Tungsten
2 Platinum-group metal
3 Target material
4 Ionic liquid
5 Glass substrate
6 Tungsten atom
7 Platinum-group metal atom
8 Fine composite metal particles
9 Powdered support
10 Exhaust gas purification catalyst

1. An exhaust gas purification catalyst comprising fine composite metal particles containing a platinum-group metal and tungsten,
wherein when the fine composite metal particles in the exhaust gas purification catalyst have been analyzed by STEM-EDX, the tungsten content of at least 80% of the fine composite metal particles based on number, is in the range of 10% to 350% of the mean content of tungsten in a plurality of the fine composite metal particles.

2. An exhaust gas purification catalyst according to claim 1, further having a powdered support, and the fine composite metal particles being supported on the powdered support.

3. An exhaust gas purification catalyst according to claim 2, wherein the powdered support is a powdered support selected from the group consisting of CeO₂—ZrO₂, SiO₂, ZrO₂, CeO₂, Al₂O₃, TiO₂ and combinations thereof.

4. A method for producing an exhaust gas purification catalyst, comprising sputtering on a target material containing a platinum-group metal and tungsten.

5. The method according to claim 4, further comprising dropping a plurality of fine composite metal particles into the ionic liquid by sputtering.

6. The method according to claim 4, further comprising supporting the fine composite metal particles on a powdered support.

7. The method according to claim 4, wherein the target material is a discoid material in which the platinum-group metal and the tungsten are alternately arranged.

8. The method according to claim 5, wherein the ionic liquid is selected from the group consisting of aliphatic ionic liquids, imidazolium-based ionic liquids, pyridinium-based ionic liquids, and combinations thereof.

9. The method according to claim 5, further comprising supporting the fine composite metal particles on a powdered support.

10. The method according to claim 5, wherein the target material is a discoid material in which the platinum-group metal and the tungsten are alternately arranged.

11. The method according to claim 6, wherein the target material is a discoid material in which the platinum-group metal and the tungsten are alternately arranged.

12. The method according to claim 9, wherein the target material is a discoid material in which the platinum-group metal and the tungsten are alternately arranged.

13. The method according to claim 6, wherein the ionic liquid is selected from the group consisting of aliphatic ionic liquids, imidazolium-based ionic liquids, pyridinium-based ionic liquids, and combinations thereof.

14. The method according to claim 7, wherein the ionic liquid is selected from the group consisting of aliphatic ionic liquids, imidazolium-based ionic liquids, pyridinium-based ionic liquids, and combinations thereof.

15. The method according to claim 9, wherein the ionic liquid is selected from the group consisting of aliphatic ionic liquids, imidazolium-based ionic liquids, pyridinium-based ionic liquids, and combinations thereof.

16. The method according to claim 10, wherein the ionic liquid is selected from the group consisting of aliphatic ionic liquids, imidazolium-based ionic liquids, pyridinium-based ionic liquids, and combinations thereof.

17. The method according to claim 11, wherein the ionic liquid is selected from the group consisting of aliphatic ionic liquids, imidazolium-based ionic liquids, pyridinium-based ionic liquids, and combinations thereof.

18. The method according to claim 12, wherein the ionic liquid is selected from the group consisting of aliphatic ionic liquids, imidazolium-based ionic liquids, pyridinium-based ionic liquids, and combinations thereof.
